(19) United States
(12) Patent Application Publication
(10) Pub. No.: US 2025/0381466 A1
(43) Pub. Date: Dec. 18, 2025

(54) SYSTEMS AND METHODS FOR USE OF SPATIAL COMPUTING IN FITNESS AND INSTRUCTIONAL APPLICATIONS

(71) Applicant: Andre Elijah Fedor, Los Angeles, CA (US)

(72) Inventor: Andre Elijah Fedor, Los Angeles, CA (US)

(21) Appl. No.: 19/017,151

(22) Filed: Jan. 10, 2025

Related U.S. Application Data
(60) Provisional application No. 63/626,176, filed on Jan. 29, 2024.

(51) Int. Cl. A63B 71/06; G06T 13/40; G06T 19/00

(52) U.S. Cl. CPC A63B 71/0622; G06T 13/40; G06T 19/006; A63B 2071/0636; A63B 2071/0638; A63B 2071/065; G06T 2200/24

(57) ABSTRACT

A “Little Buddy Video” system may feature miniaturized versions of video screens placed to the front, left, and right of the user's position. These miniaturized versions of the virtual screen may be positioned closer to the ground/floor, allowing the user to still be able to see what is being displayed on the screens while the user bends and moves without having to strain to see the large virtual screen that may be straight ahead of the user. A “Little Buddy” system may feature a miniaturized version of a trainer avatar placed to the front, left, and right of the user's yoga mat position. The miniaturized avatar may move through predefined poses identical to the regular trainer avatar that may be displayed on a large virtual screen. Drishti points in a user's environment (real or virtual) may help maintain balance in certain poses and improve focus in general.

### CROSS-REFERENCE TO RELATED APPLICATION

The present Application is a non-provisional of, and claims priority to, U.S. Patent Application No. 63/626,176 filed Jan. 29, 2024, the disclosure of which is incorporated by reference in its entirety.

### FIELD OF THE DISCLOSURE

The present disclosure generally relates to spatial computing, and more particularly to systems and methods for use of spatial computing in fitness and instructional applications.

### BACKGROUND

When a user wears a head-mounted display (HMD), the user may have a difficult time viewing and interacting with virtual screens or virtual objects+3D models that are positioned straight ahead relative to the user. These virtual screens or virtual objects+3D models also can be cumbersome and dangerous for the user due to factors including, but not limited to, the weight of the HMD and neck strain. In addition, when users are wearing headsets with typical fitness/mindfulness+instructional/training applications and games, it can be difficult to maintain balance, footing, and/or focus. Moreover, with many fitness and instructional/training applications, the user may have to stop or pause the application to check his/her form or to adjust his/her position. These stops/pauses may result in less satisfactory user experience.

### SUMMARY

Embodiments of the present disclosure may provide a “Little Buddy Video” system that may feature miniaturized versions of video screens placed to the front, behind, left, and right of the user's position. A video may play on a traditional large virtual screen in front of the user, and there may be miniaturized versions of that screen that may be displayed around the user. These miniaturized versions of the virtual screen may be positioned closer to the ground/floor, allowing the user to still be able to see what is being displayed on the screens while the user bends and moves without having to strain to see the large virtual screen that may be straight ahead of the user. Embodiments of the present disclosure also may provide a “Little Buddy” system that may feature a miniaturized version of a trainer avatar or virtual object+3D model placed to the front, behind, left, and right of the user's yoga mat or training position. The miniaturized avatar may move through predefined poses identical to the regular trainer avatar that may be displayed at full human-scale in embodiments of the present disclosure. The system may allow users to easily see what the trainer is doing while performing poses that may not always accommodate looking directly forward where the full-size avatar may be positioned. Embodiments of the present disclosure may further provide Drishti points to help maintain balance in certain poses, and also improve focus in general. By providing Drishti points in a user's environment (real or virtual), more focused and targeted sessions may be guided.

Embodiments of the present disclosure may provide a method for use of spatial computing in fitness and instructional applications comprising: using spatial computing through a virtual, augmented reality, and/or mixed reality headset, delivering miniaturized versions of video screens to the front, behind, left, and right of a user's training position; and displaying fitness and instructional content on the miniaturized versions of video screens, wherein the user is capable of viewing the fitness and instructional content when not looking directly forward at a traditional large virtual screen, and wherein the miniaturized versions of video screens are rendered textures of the fitness and instructional content replicated as a plurality of rectangle primitives to the miniaturized versions of video screens. Little Buddy may be initially rendered by calculating the ground plane of the user as well as their forward direction and placing the miniature avatars and screens on the ground and around the various sides of the users. This creates a perspective-correct view of the avatars and screens, that blend and sit in the real world. The miniaturized versions of video screens may be positioned lower to the ground than the traditional large virtual screen. The user may be capable of seeing what is displayed on the miniaturized versions of video screens while the user bends and moves. When the traditional large virtual screen displays a fitness application, the user may be capable of following a fitness instructor on the traditional large virtual screen regardless the position of the user at any given time. The spatial computing may be provided through or within an instructional application and/or through a video player. An additional miniaturized version of a video screen may be provided in front of the user below the traditional large virtual screen. The traditional large virtual screen may be positioned forward of the additional miniaturized version of the video screen. The method also may include using spatial computing, delivering miniaturized versions of a trainer avatar to the front, behind, left, and right of the user's training position; and displaying predefined poses, maneuvers and/or exercises via the miniaturized versions of the trainer avatar, wherein the user is capable of viewing the predefined poses, maneuvers and/or exercises via the miniaturized versions of the trainer avatar when not looking directly forward at a regular trainer avatar on the traditional large virtual screen. The miniaturized versions of the trainer avatar may be capable of being manually rotated by the user to a preferred angle. The miniaturized versions of the trainer avatar may remain in view of the user when the user turns his/her head. The miniaturized versions of the trainer avatar may show one or more muscle groups affected by a particular exercise. The miniaturized versions of the trainer avatar may have different shapes and sizes selectable by the user. The method also may include using spatial computing, providing one or more Drishti points in a training environment of the user to focus and/or target the fitness and instructional applications for the user.

Other embodiments of the present disclosure may provide a method for use of spatial computing in fitness and instructional applications comprising: using spatial computing through a virtual, augmented reality, and/or mixed reality headset, delivering miniaturized versions of a trainer avatar to the front, behind, left, and right of a user's training position; and displaying predefined poses, maneuvers and/or exercises via the miniaturized versions of the trainer avatar, wherein the user is capable of viewing the predefined poses, maneuvers and/or exercises via the miniaturized versions of the trainer avatar when not looking directly forward at a regular trainer avatar on a traditional large virtual screen. The method also may include using spatial computing, delivering miniaturized versions of video screens to the front, behind, left, and right of the user's training position; and displaying fitness and instructional content on the miniaturized versions of video screens, wherein the user is capable of viewing the fitness and instructional content when not looking directly forward at the traditional large virtual screen, and wherein the miniaturized versions of video screens are rendered textures of the fitness and instructional content replicated as a plurality of rectangle primitives to the miniaturized versions of video screens. When the traditional large virtual screen displays a fitness application, the user may be capable of following a fitness instructor on the traditional large virtual screen regardless the position of the user at any given time. The miniaturized versions of the trainer avatar may show one or more muscle groups affected by a particular exercise. The miniaturized versions of the trainer avatar have different shapes and sizes selectable by the user. The method also may include using spatial computing, providing one or more Drishti points in a training environment of the user to focus and/or target the fitness and instructional applications for the user.

### BRIEF DESCRIPTION OF THE DRAWINGS

For a more complete understanding of this disclosure, reference is now made to the following description, taken in conjunction with the accompanying drawings, in which:

FIGS. 1A-1C depict a “Little Buddy Video” system according to an embodiment of the present disclosure;

FIGS. 2A-2D depict examples of avatars that may be employed as part of the “Little Buddy” system according to an embodiment of the present disclosure;

FIGS. 3A-3D depict miniaturized and large avatars in use as part of the “Little Buddy” system according to an embodiment of the present disclosure;

FIGS. 4A-4C depict Drishti points in a variety of formats according to an embodiment of the present disclosure;

FIGS. 5A-5B depict Drishti points relative to a large virtual screen according to an embodiment of the present disclosure; and

FIGS. 5C-5E depict other views of miniaturized and large avatars in use as part of the “Little Buddy” system according to an embodiment of the present disclosure.

### DETAILED DESCRIPTION

Embodiments of the present disclosure may provide a “Little Buddy Video” system that may feature miniaturized versions of video screens placed to the front, behind, left, and right of the user's position. While certain directions/positions are described herein, it should be appreciated that the miniaturized versions of video screens may be positioned in different directions and/or there may be more or fewer miniaturized versions of video screens in embodiments of the present disclosure. This system may allow a user to easily see what video content may be displayed even when the user may not be looking directly forward. More specifically, in an embodiment of the present disclosure, a video may play on a traditional large virtual screen in front of the user, and there may be miniaturized versions of that screen that may be displayed around the user. These miniaturized versions of the virtual screen may be positioned closer to the ground/floor, allowing the user to still be able to see what is being displayed on the screens while the user bends and moves without having to strain to see the large virtual screen that may be straight ahead of the user. Accordingly, when the user is utilizing a fitness application, the user may be able to follow the fitness instructor on the video regardless the position of the user at any given time. This may make the experience less cumbersome and safer for the user. In embodiments of the present disclosure, the system may be provided through or within an instructional application (app) or video player for use in a variety of areas, including but not limited to, fitness training and/or entertainment.

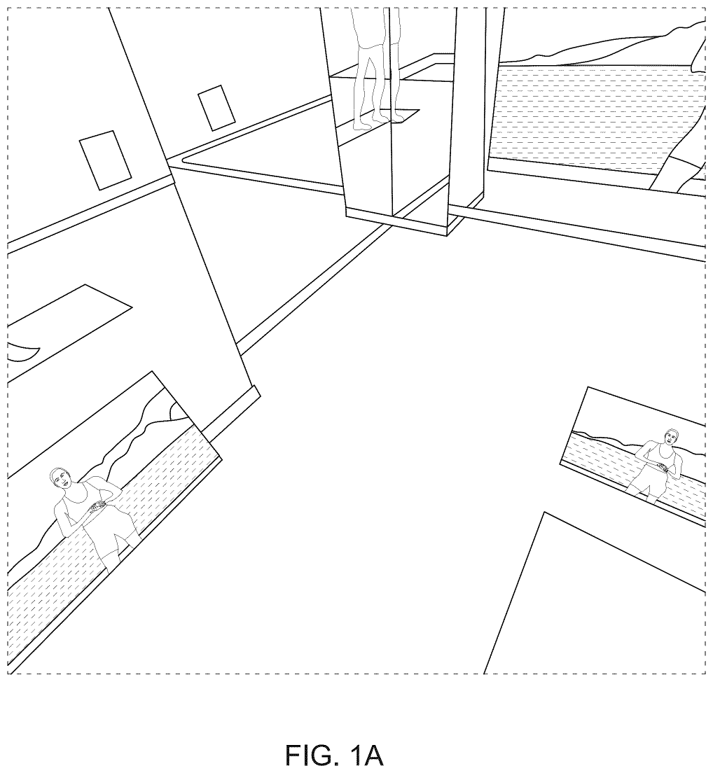

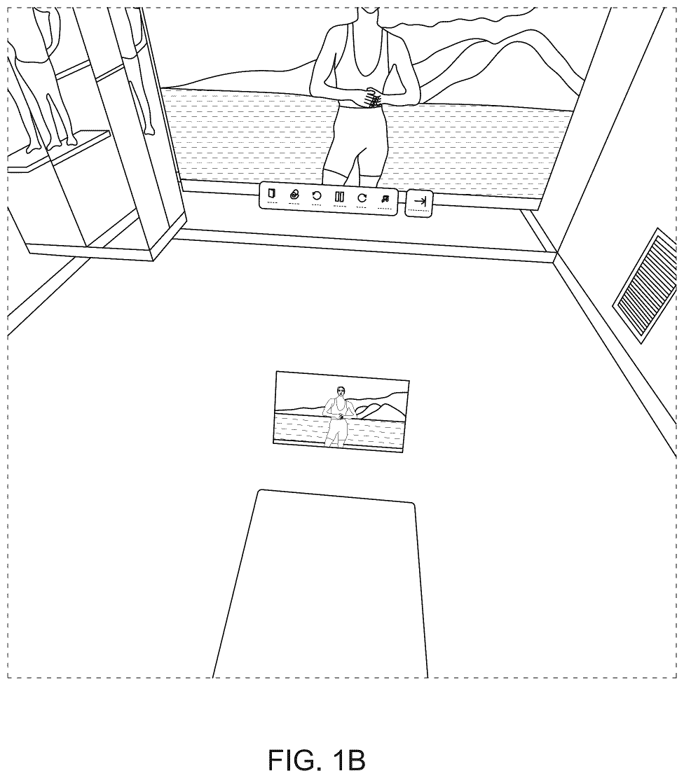

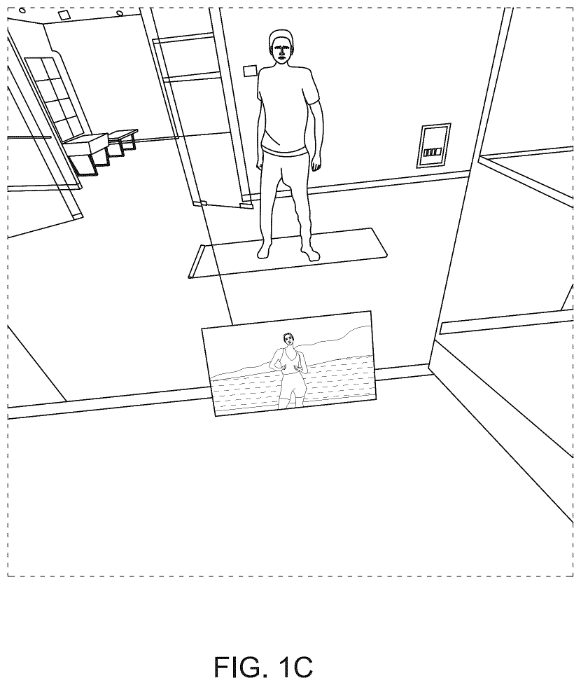

FIGS. 1A-1C depict a “Little Buddy Video” system according to an embodiment of the present disclosure. As depicted in FIG. 1A, the large virtual screen may be positioned at the front of a room or area where the user is receiving instruction. The user may be utilizing a mat as depicted in FIG. 1A, and as depicted herein, a miniaturized screen may be displayed in front of the user in an area closer to the ground/floor relative to the large virtual screen that may be positioned more forward of that miniaturized screen. While a mat is depicted in FIG. 1A, it should be appreciated that a mat is not required in embodiments of the present disclosure. Another miniaturized screen may be displayed to the left of the user's mat as depicted in FIG. 1A. FIG. 1B depicts another view of the large virtual screen that may be positioned at the front of a room/area, and the miniaturized screen that may be displayed closer to the user and his/her mat, closer to the ground/floor than the large virtual screen. FIG. 1C depicts a view of a miniaturized screen as it may be seen relative to where a user may be situated on his/her mat and relative to mirrors that may be present in a room/area where the system is being used.

Similar to the “Little Buddy Video” system described with respect to FIGS. 1A-1C, the “Little Buddy” system according to embodiments of the present disclosure may feature a miniaturized version of a trainer avatar placed to the front, left, and right of the user's yoga mat position. The miniaturized avatar may move through predefined poses, maneuvers, and/or exercises identical to the regular trainer avatar that may be displayed at full human-scale, for example, on a large virtual screen in embodiments of the present disclosure. The system may allow users to easily see what the trainer is doing while performing poses, maneuvers, and/or exercises that may not always accommodate looking directly forward where the large virtual screen may be positioned. In some embodiments of the present disclosure, users may manually rotate the pedestal on which Little Buddy is placed, letting the users view poses, maneuvers, and/or exercises from their preferred angle. Through user experience testing, many participants reported that utilizing the “Little Buddy” system may set a fitness application apart from the other fitness applications. Use of the “Little Buddy” system may reduce the user's need to pause the instructor to check their poses or crane their necks. Participants were pleased to learn that the “Little Buddy” stayed in their view when they turned their heads. The system according to embodiments of the present disclosure may be provided through or within an instructional application (app) or video player for use in a variety of areas, including but not limited to, fitness training and/or entertainment. It may be particularly useful in fitness training where seeing a miniaturized version of the human body in different poses may provide an optimal experience as opposed to the user relying solely on traditional flatscreen videos or slides.

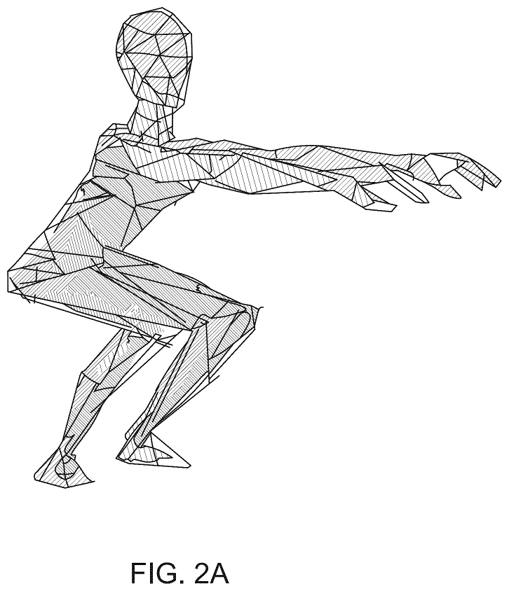

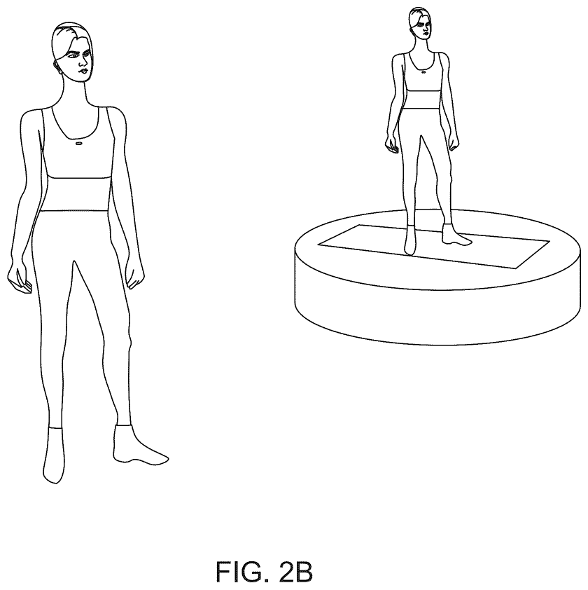

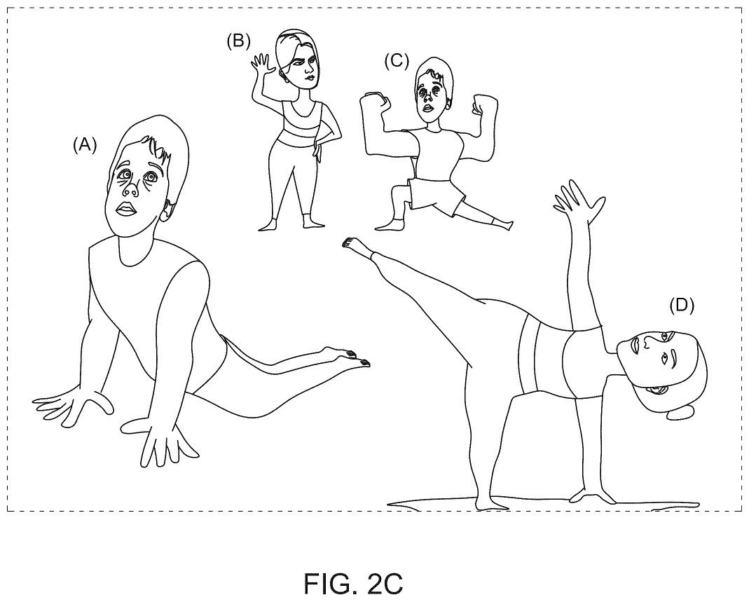

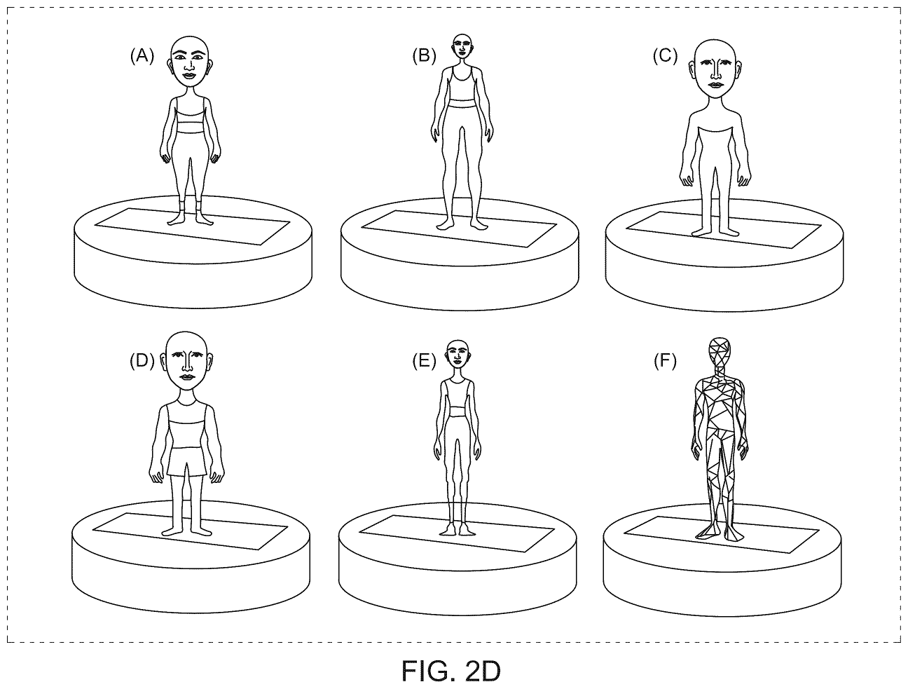

FIGS. 2A-2D depict examples of avatars that may be employed as part of the “Little Buddy” system according to an embodiment of the present disclosure. FIG. 2A depicts an avatar that may display where the user may feel a stretch or feel pressure or is being directly targeted during a particular fitness move. In particular, FIG. 2A shows the muscle groups affected by a particular exercise on an avatar/Little Buddy. It should be appreciated that this display may be generalized to an avatar at full-scale and/or miniaturized in embodiments of the present disclosure.

FIG. 2B depicts an avatar standing on the floor and then standing on a mat on a platform. FIGS. 2C and 2D depict how the avatars may look when performing different fitness moves as well as different sizes and shapes of avatars, including wearing different clothing. It should be appreciated that the avatar may be set within the application in embodiments of the present disclosure; however, there may be embodiments of the present disclosure where the user may select the avatar that he/she wishes to follow. This may be an avatar that is similar to the user's build/physique or may be entirely different from the user in embodiments of the present disclosure.

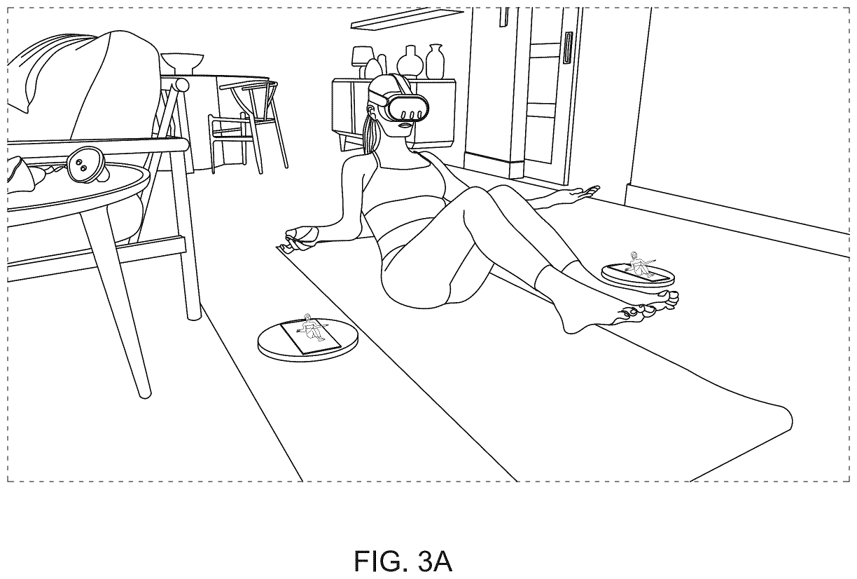

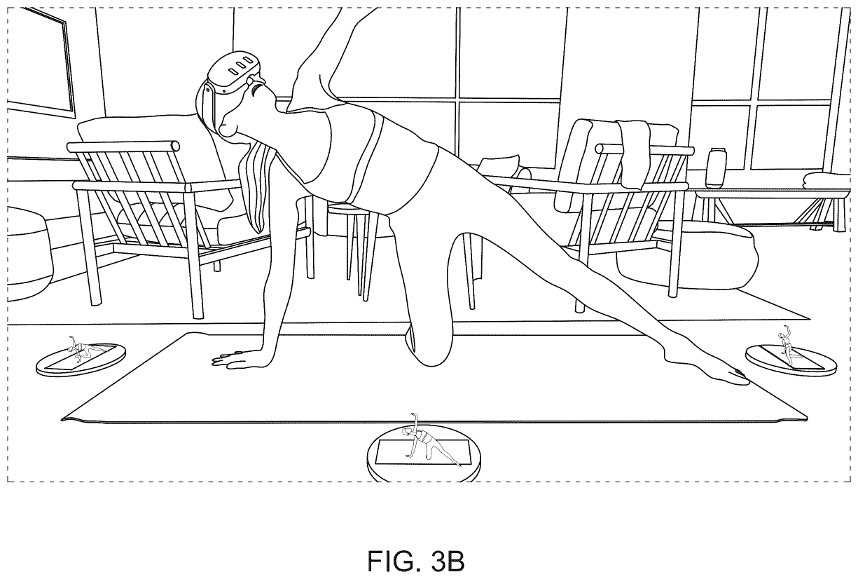

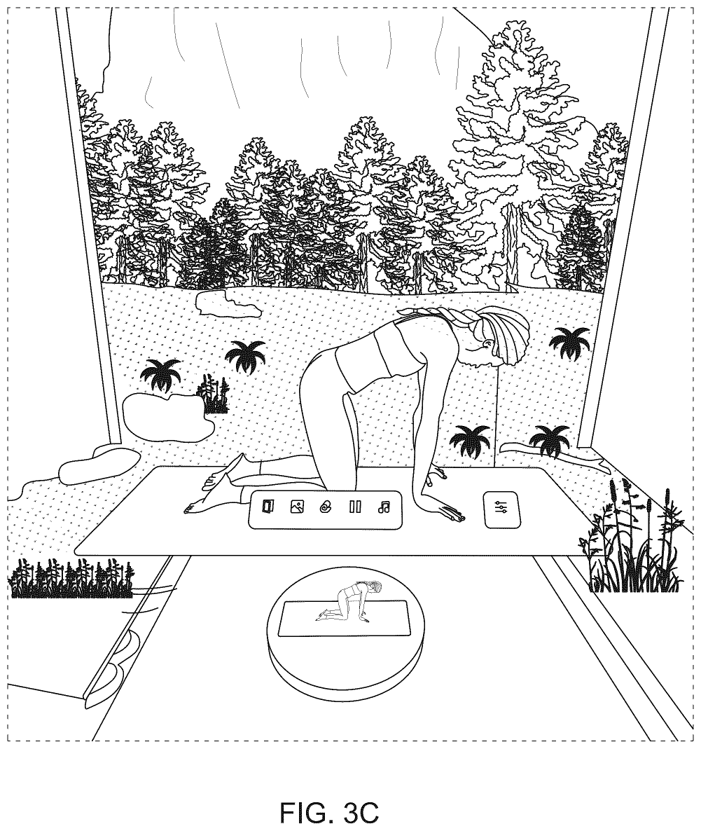

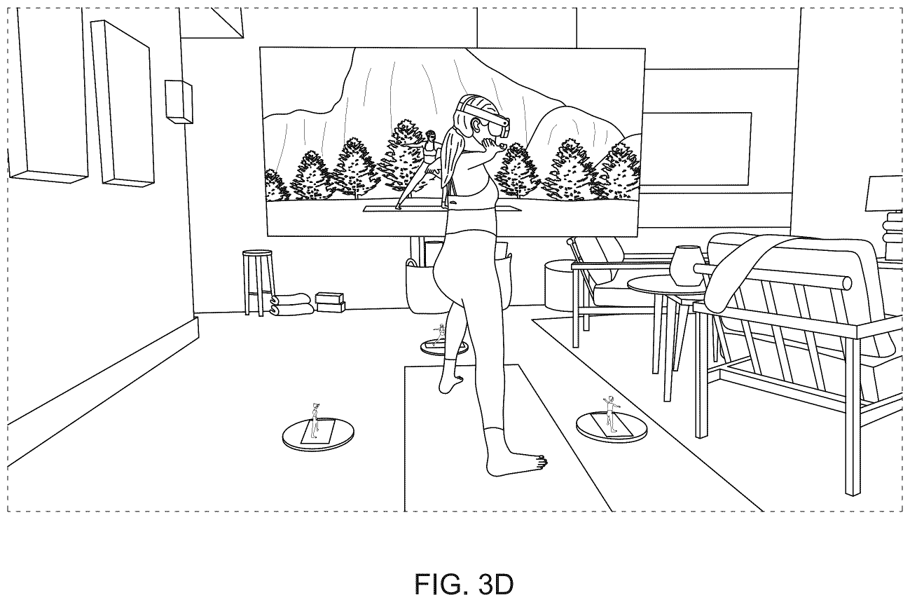

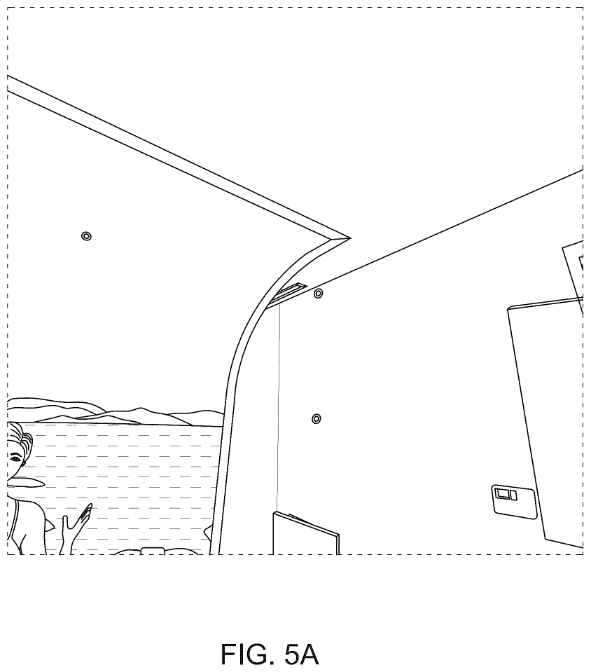

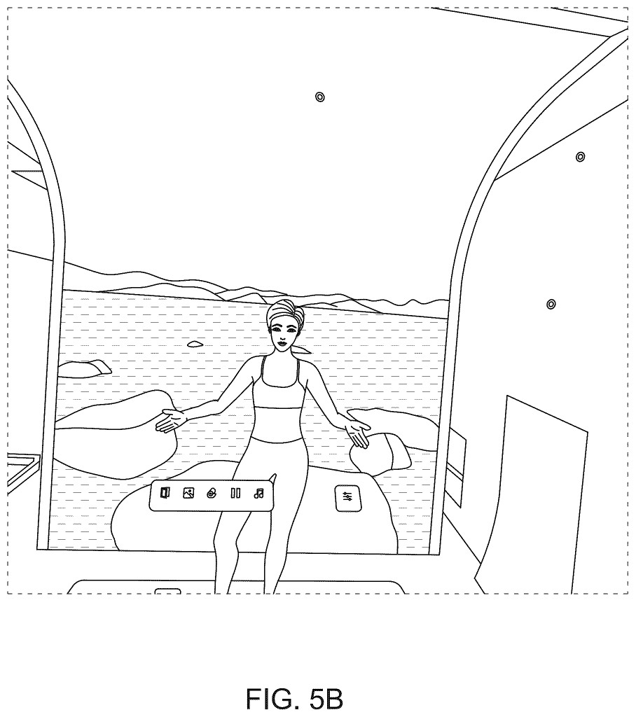

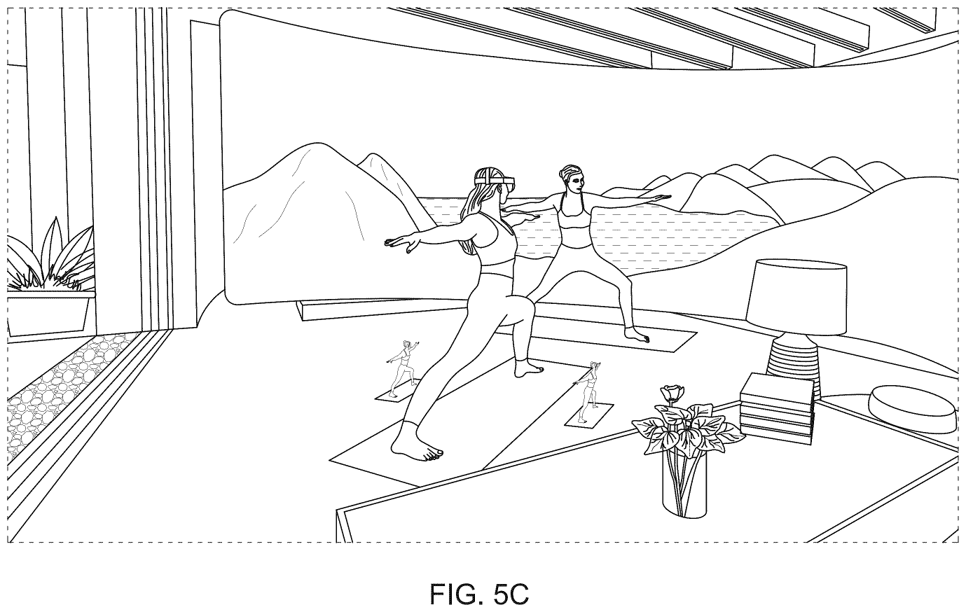

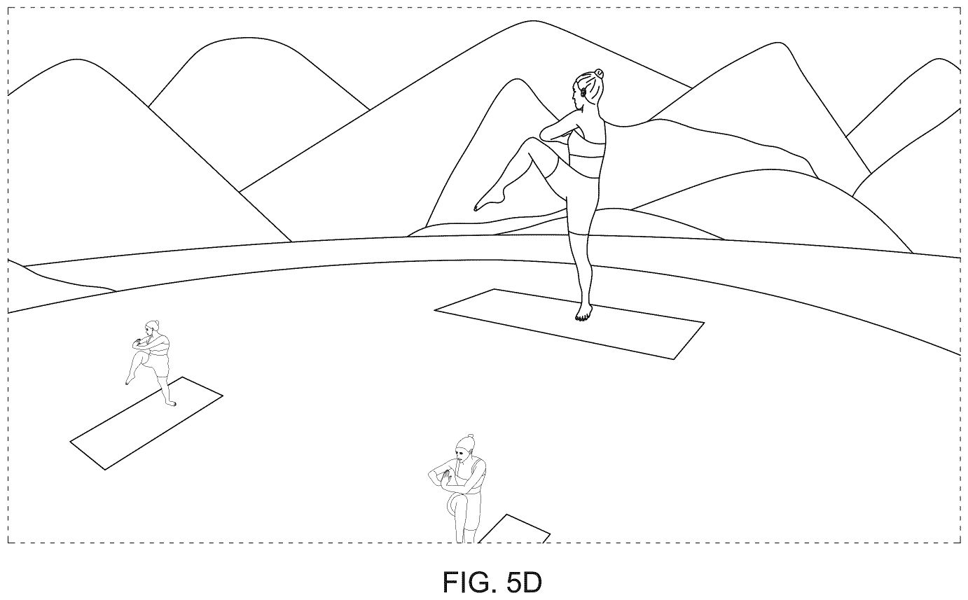

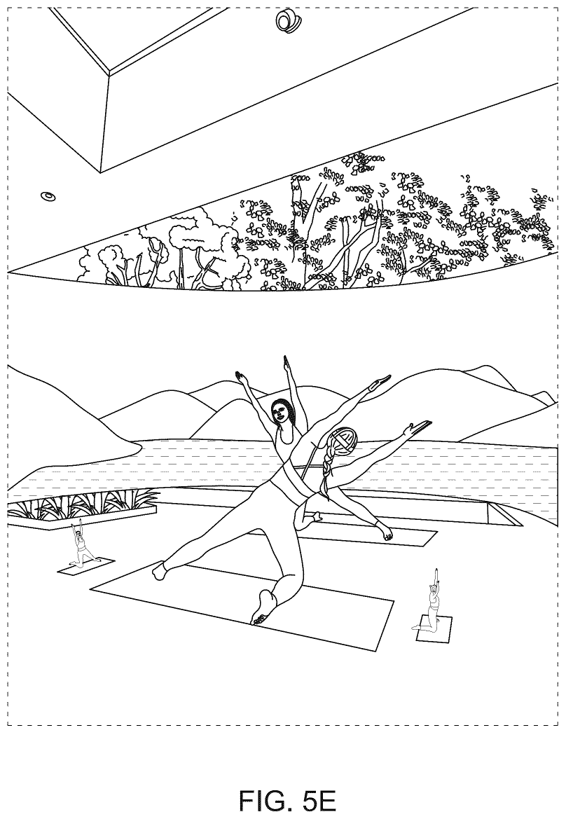

FIGS. 3A-3D depict miniaturized and large avatars in use as part of the “Little Buddy” system according to an embodiment of the present disclosure. In FIG. 3A, the user may be sitting on a yoga mat employing a virtual reality (VR) headset to perform a fitness move, and miniaturized avatars are displayed on either side of the user in similar positions performing the same fitness move. Accordingly, if the user looks to her right or left side while performing the fitness move, she may see the miniaturized avatars performing the fitness move, and she can make adjustments to her position without having to look straight ahead where the large virtual screen may be positioned relative to the user. FIG. 3B depicts the same user as in FIG. 3A performing a fitness move, and there may be miniaturized avatars displayed lengthwise along the yoga mat as well as at the head and foot of the yoga mat in this embodiment of the present disclosure, as these may be the locations where the user is most likely to be able to look while performing the fitness move. Accordingly, the user may look in any of these directions around her yoga mat to see if she is performing the fitness move correctly or may need to make adjustments relative to the move of the miniaturized avatars. While FIGS. 3A and 3B are described with respect to yoga, it should be appreciated that the miniaturized avatars may be utilized in exercises or activities other than yoga without departing from the present disclosure. FIG. 3C depicts an embodiment where the user may be able to see the large virtual screen where the avatar may be performing the fitness move as well as the miniaturized avatar that may be displayed lower to the ground/floor in front of the large virtual screen. This may be helpful to the user, such as when the user is performing a fitness move sitting or lying down on the yoga mat. FIG. 3D depicts a similar scenario to FIG. 3C where there may be a miniaturized avatar forward of the large virtual screen but closer to the ground/floor than the avatar depicted on the large virtual screen. However, FIG. 3D also depicts how miniaturized avatars may be displayed on the right and left sides of the user. Accordingly, the user may be able to see the miniaturized avatars to the front or to the sides as she is performing a fitness move. FIGS. 5C-5E depict other views of miniaturized and large avatars in use as part of the “Little Buddy” system according to an embodiment of the present disclosure.

Drishti is a yoga concept of a focus point, to be used in spatial computing applications. Drishti is the method of gazing at a focal point in yoga practice. In this context, it can help maintain balance in certain poses, but can also improve focus in general. By providing Drishti points in a user's environment (real or virtual), more focused and targeted sessions may be guided. Different Drishti points can also provide a more challenging experience, allowing users to “level up” at their comfort level. The Drishti allows for that, particularly in fitness and training applications where the user is more prone to lose their balance and footing which is especially dangerous when the user is wearing a HMD of some sort. Accordingly, fitness, training, and/or wellness applications that leverage virtual, augmented reality, and/or mixed reality headsets may utilize the Drishti points in embodiments of the present disclosure.

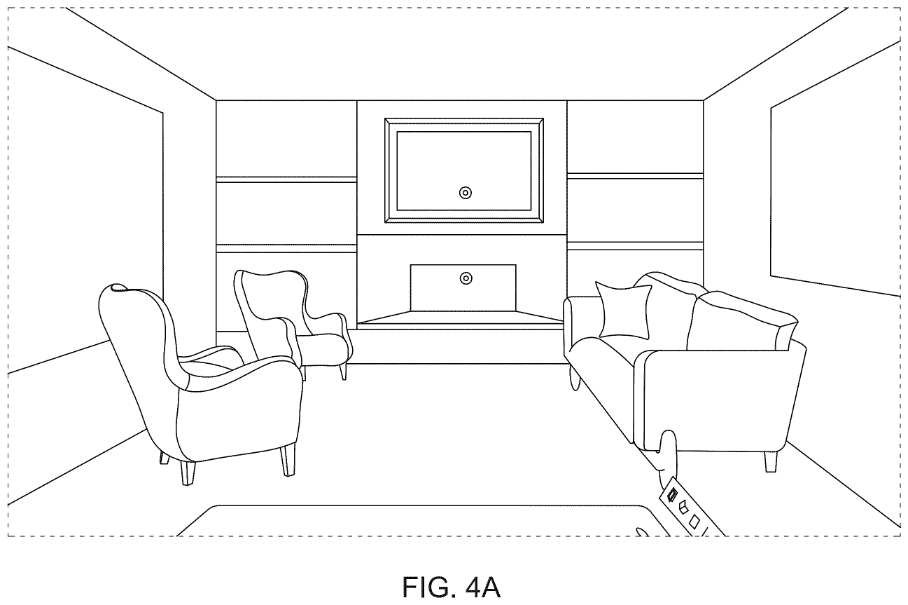

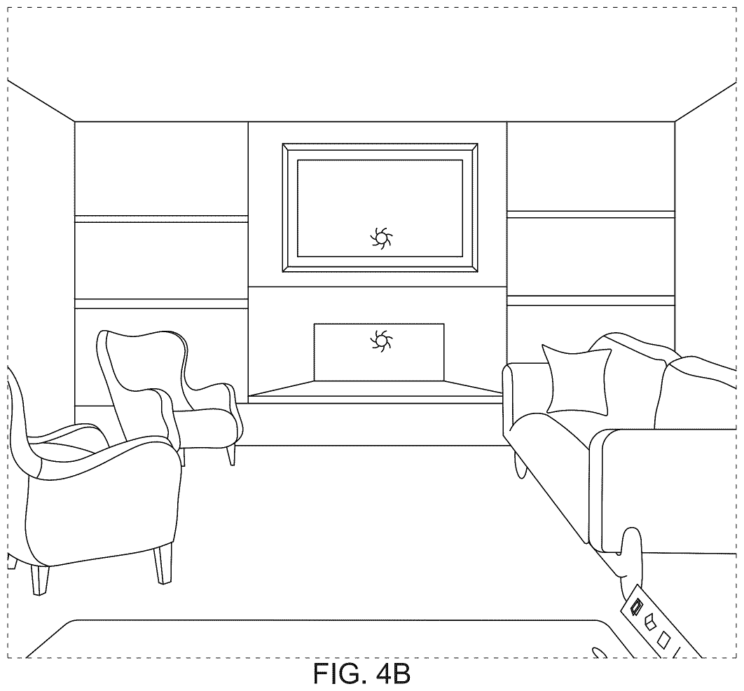

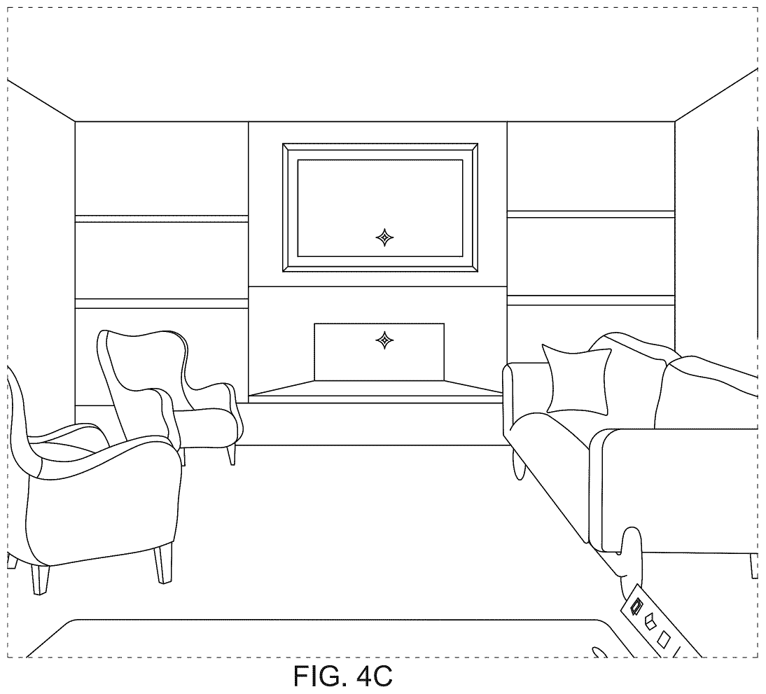

FIGS. 4A-4C depict Drishti points in a variety of formats according to an embodiment of the present disclosure. FIGS. 5A-5B depict Drishti points relative to a large virtual screen according to an embodiment of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for use of spatial computing in fitness and instructional applications comprising:
using spatial computing through a virtual, augmented reality, and/or mixed reality headset, delivering miniaturized versions of video screens to the front, behind, left, and right of a user's training position; and
displaying fitness and instructional content on the miniaturized versions of video screens, wherein the user is capable of viewing the fitness and instructional content when not looking directly forward at a traditional large virtual screen, and
wherein the miniaturized versions of video screens are rendered textures of the fitness and instructional content replicated as a plurality of rectangle primitives to the miniaturized versions of video screens.

2. The method of claim 1, wherein the miniaturized versions of video screens are positioned lower to the ground than the traditional large virtual screen.

3. The method of claim 2, wherein the user is capable of seeing what is displayed on the miniaturized versions of video screens while the user bends and moves.

4. The method of claim 2, wherein when the traditional large virtual screen displays a fitness application, the user is capable of following a fitness instructor on the traditional large virtual screen regardless the position of the user at any given time.

5. The method of claim 1, wherein the spatial computing is provided through or within an instructional application.

6. The method of claim 1, wherein the spatial computing is provided through a video player.

7. The method of claim 1, wherein an additional miniaturized version of a video screen in front of the user below the traditional large virtual screen.

8. The method of claim 7, wherein the traditional large virtual screen is positioned forward of the additional miniaturized version of the video screen.

9. The method of claim 1 further comprising:
using spatial computing, delivering miniaturized versions of a trainer avatar to the front, behind, left, and right of the user's training position; and
displaying predefined poses, maneuvers and/or exercises via the miniaturized versions of the trainer avatar, wherein the user is capable of viewing the predefined poses, maneuvers and/or exercises via the miniaturized versions of the trainer avatar when not looking directly forward at a regular trainer avatar on the traditional large virtual screen.

10. The method of claim 9, wherein the miniaturized versions of the trainer avatar are capable of being manually rotated by the user to a preferred angle.

11. The method of claim 9, wherein the miniaturized versions of the trainer avatar remain in view of the user when the user turns his/her head.

12. The method of claim 9, wherein the miniaturized versions of the trainer avatar show one or more muscle groups affected by a particular exercise.

13. The method of claim 9, wherein the miniaturized versions of the trainer avatar have different shapes and sizes selectable by the user.

14. The method of claim 1 further comprising:
using spatial computing, providing one or more Drishti points in a training environment of the user to focus and/or target the fitness and instructional applications for the user.

15. A method for use of spatial computing in fitness and instructional applications comprising:
using spatial computing through a virtual, augmented reality, and/or mixed reality headset, delivering miniaturized versions of a trainer avatar to the front, behind, left, and right of a user's training position; and
displaying predefined poses, maneuvers and/or exercises via the miniaturized versions of the trainer avatar, wherein the user is capable of viewing the predefined poses, maneuvers and/or exercises via the miniaturized versions of the trainer avatar when not looking directly forward at a regular trainer avatar on a traditional large virtual screen.

16. The method of claim 15 further comprising:
using spatial computing, delivering miniaturized versions of video screens to the front, behind, left, and right of the user's training position; and
displaying fitness and instructional content on the miniaturized versions of video screens, wherein the user is capable of viewing the fitness and instructional content when not looking directly forward at the traditional large virtual screen, and
wherein the miniaturized versions of video screens are rendered textures of the fitness and instructional content replicated as a plurality of rectangle primitives to the miniaturized versions of video screens.

17. The method of claim 16, wherein when the traditional large virtual screen displays a fitness application, the user is capable of following a fitness instructor on the traditional large virtual screen regardless the position of the user at any given time.

18. The method of claim 15, wherein the miniaturized versions of the trainer avatar show one or more muscle groups affected by a particular exercise.

19. The method of claim 15, wherein the miniaturized versions of the trainer avatar have different shapes and sizes selectable by the user.

20. The method of claim 15 further comprising:
using spatial computing, providing one or more Drishti points in a training environment of the user to focus and/or target the fitness and instructional applications for the user.
